(19) United States
(12) Patent Application Publication
(10) Pub. No.: US 2015/0134246 A1
(43) Pub. Date: May 14, 2015

(54) MULTI-PATH ROUTING TELEMATICS SYSTEM AND METHOD

(71) Applicant: Hyundai Motor Company, Seoul (KR)

(72) Inventor: Dong Hyuk Oh, Seoul (KR)

(21) Appl. No.: 14/482,348

(22) Filed: Sep. 10, 2014

(30) Foreign Application Priority Data
Nov. 12, 2013 (KR) 10-2013-0137065

(51) Int. Cl. G01C 21/00

(52) U.S. Cl. CPC G01C 21/00
USPC 701/533; 701/537

(57) ABSTRACT

A multi-path routing telematics system and method are provided. The method includes receiving, by a controller, a route request from a navigation device and connecting to one or more route-providing servers based on corresponding plug-ins. In addition, the controller is configured to collect routes and transmit them to the navigation device. The route-providing servers are each configured to create a route pursuant to the route request.

### CROSS-REFERENCE TO RELATED APPLICATION

This application is based on and claims priority from Korean Patent Application No. 10-2013-0137065, filed on Nov. 12, 2013 in the Korean Intellectual Property Office, the disclosure of which is incorporated herein in its entirety by reference.

### BACKGROUND

1. Field of the Invention

The present invention relates to a multi-path routing telematics system and method, and more particularly, to a multi-path routing telematics system that collects route information from one or more route-providing servers upon a user request for routes to provide the user with the information.

2. Description of the Prior Art

Previously, an automotive navigation system has provided the routing function using a map installed in the navigation device and an algorithm, without being connected to external servers, and thus it has been difficult to incorporate traffic information into the routing. Recent audio video navigation (AVN) devices, however, communicate with external servers by connecting to a telematics device, and thus the automotive navigation devices have also evolved to obtain traffic information via external servers to apply the information in routing or to receive a route from an external server to apply the information in routing.

Similarly, as smart phone technology advances, more smart phones are being equipped with the navigation feature. Since many smart phones provide data communications with external servers, the navigation service provided by smart phones is advantageous in that route information, traffic information, etc., as well as a map can be received from a server to be used. However, it is disadvantageous in that it depends on global positioning system (GPS) information of smart phones and is not associated with traveling information of a vehicle and thus may be less likely to be used in vehicles.

Internet portal enterprises have real-time routing services, traffic information and other road information and provide routing services which incorporate traffic information and road information via portal pages. Although real-time routing is not provided by those internet portal enterprises, no additional map or complex capabilities in smart phones or automotive AVNs is required, and the services by those internet portal enterprises can be provided to vehicles or smart phones with web browsers conforming to the web standard. Due to this trend, customers would like to be able to compare various routes to choose a preferred route. Accordingly, a technology that allows customers who have purchased automotive navigation devices to compare route information provided from different information providers to select a route and to be guided is required.

### SUMMARY

Accordingly, the present invention provides a multi-path routing telematics system that collects route information from one or more route-providing servers via a standardized interface in the form of a plug-in upon a user request for routes and then provides a routing service based on the route information chosen by the user. Accordingly, the user may compare the route information from various routing service providers and may choose a route in view of his situation, preference or propensity and may be guided along that route, thereby improving reliability and satisfaction on an automotive navigation device.

In one aspect of the present invention, a multi-path routing telematics system may include a navigation device configured to request a route from a telematics module and to receive a route therefrom to provide routing; the telematics module may be configured to connect to one or more route-providing servers based on corresponding plug-ins and to collect routes and transmit the routes to the navigation device; and the route-providing servers may each be configured to create a route pursuant to a request for a route from the telematics module and to provide the route to a user.

### BRIEF DESCRIPTION OF THE DRAWINGS

The above and other objects, features and advantages of the present invention will be more apparent from the following detailed description taken in conjunction with the accompanying drawing, in which:

FIG. 1 is an exemplary block diagram of a multi-path routing telematics system according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described in detail with reference to the accompanying drawings.

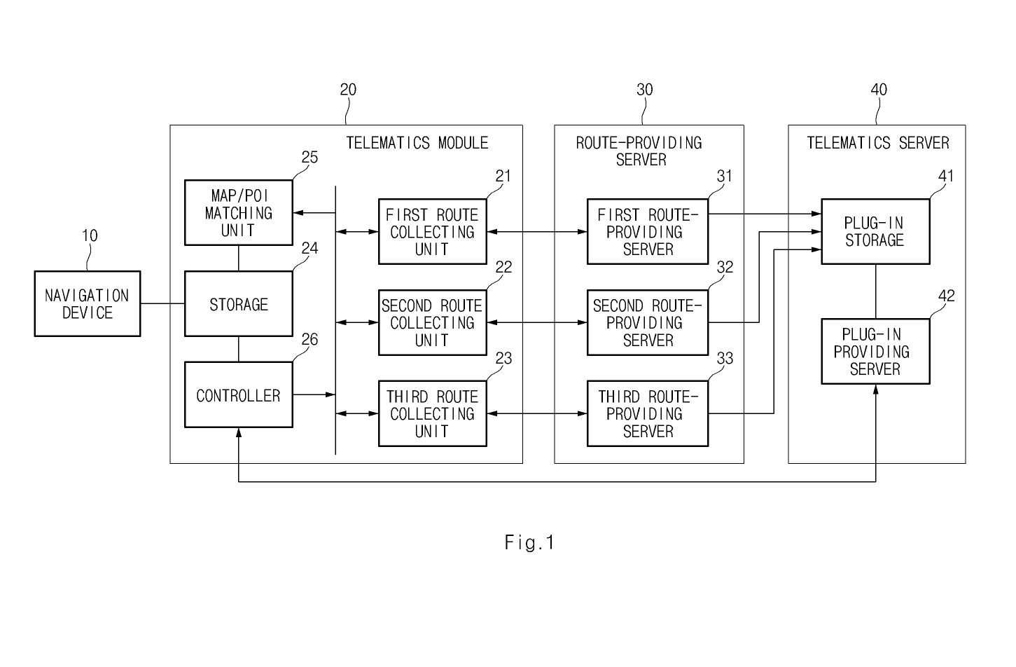

FIG. 1 is an exemplary block diagram of a multi-path routing telematics system according to an exemplary embodiment of the present invention. As shown in FIG. 1, the multi-path routing telematics system may include a navigation device 10, a telematics module 20, a route-providing server 30, and a telematics server 40.

Specifically, the navigation device 10 may be a terminal installed within a vehicle and may be executed by a controller to guide a route from a departure point to a destination. Upon receiving a departure point to a destination from a user, the navigation device 10 may be configured to transmit the departure point and destination to the telematics module 20 and request to create a route. The navigation device 10 may be configured to transmit a stopover point and requirements for creating a route (e.g., the shortest distance, the shortest time, etc.) along with the request. When the navigation device 10 receives route information from the telematics module 20 the navigation device 10 may be configured to provide a routing service based on the received information.

In addition, the navigation device 10 may be configured to request point of interest (POI) information (e.g., a parking lot, a gas station, etc.) from the telematics module 20 when a user requests the POI information. Then, the navigation device 10 may be configured to receive the POI information from the telematics module 20 and marks the information on a map. Additionally, the navigation device 10 may be configured to create a route when no plug-in is installed for collecting route information and POI information from route providing servers or when a user does not request route information from route providing servers. In these cases, the navigation device 10 may include a GPS receiver and map data.

The telematics module 20 may be installed within a vehicle and may be connected to route providing servers 30 operated by service providers (e.g., the Naver coip., the Daum corp., the SK Corp., etc.) or to a telematics server 40 operated by a telematics center to receive and transmit various types of data. The telematics module 20 may be configured to download and install from the telematics server 40 a plug-in for collecting route information and POI information from route providing servers. Further, when the telematics module 20 receives a departure point and a destination from the navigation device 10, the telematics module 20 may be configured to connect to a route providing server 30 operated by a service provider via a previously installed plug-in for the service provider to be provided with a route. In particular, the telematics module 20 may be configured to store therein information regarding the navigation device 10 (e.g., map information, the type, the version, etc.) and perform map matching based on the information. The map matching may be a process of converting route information for a map used by each service provider into route information for a map used by the navigation device 10.

Additionally, when the telematics module 20 receives POI information from the navigation device 10, the telematics module 20 may be configured to connect to a route providing server 30 operated by a service provider via a previously installed plug-in for the service provider to be provided with the POI information. In particular, the telematics module 20 may be configured to store therein information regarding the navigation device 10 (e.g., map information, the type, the version, etc.) and perform POI matching based on the information. The POI matching may be a process of converting POI information for a map used by each service provider into POI information for a map used by the navigation device 10. Further, when the telematics module 20 receives POI information from the navigation device 10 along with a request for a route, the telematics module 20 may be configured to connect to a route providing server 30 operated by a service provider via a previously installed plug-in for the service provider to be provided with the route and the POI information.

One or more route providing server 30 operated by the services providers (e.g., the Naver corp., the Daum corp., the SK Corp., etc.) may include, for example, a first route providing server 31 operated by the internet portal enterprise Naver corp., a second route providing server 32 operated by the internet portal enterprise Daum corp., and a third route providing server 31 operated by the SK corp. Although three route providing servers have been described herein, the number of the route providing servers is not essential to practice the present invention. The route providing servers 31, 32 and 33 may be configured to use different maps pursuant to particular policies and may have unique route creation engines to create different route information.

Moreover, the route providing servers 31, 32 and 33 may be configured to provide the telematics server 40 with plug-ins that allow the telematics module 20 to connect to the route providing servers 31, 32 and 33 to receive the route information and the POI information. Then, the telematics server 40 may be configured to manage the plug-ins provided from the route providing servers 31, 32 and 33 and provide a plug-in when the telematics module 20 requests downloading of the plug-in. In particular, the telematics server 40 may charge the downloading of the plug-in.

Hereinafter, the configurations of the above-described elements will be described in detail. The telematics module 20 may include a first route collecting unit 21, a second route collecting unit 22, a third route collecting unit 23, a storage 24, a map/POI matching unit 25, and a controller 26. The controller 26 may be configured to execute the collecting units 21, 22, and 23, the storage 24, and the map/POI matching unit 25.

The first route collecting unit 21, under the operation of the controller 26, may be configured to connect to the first route providing server 31 operated by, for example, the internet portal enterprise Naver coip., to request route creation and receive a corresponding route from the first route providing server 31. The second route collecting unit 22, under the operation of the controller 26, may be configured to connect to the second route providing server 32 operated by, for example, the internet portal enterprise the DAUM coip., to request route creation and receive a corresponding route from the second route providing server 32. The third route collecting unit 23, under the operation of the controller 26, may be configured to connect to the third route providing server 32 operate by, for example, the SK corp., to request route creation and receive a corresponding route from the third route providing server 32.

The above-described first to third route collecting units 21, 22 and 23 may be function blocks of plug-ins (e.g., add-on programs for performing specific functions) and may be configured to perform the specific functions pursuant to programmed instructions. The above-described first to third route collecting units 21, 22 and 23 may be configured to store addresses of the corresponding route providing servers and transmit a departure point, a destination, a stopover point, detail conditions to a corresponding server to request route creation. The above-described first to third route collecting units 21, 22 and 23 perform may also be configured to perform user authentication.

The storage 24 may be configured to store information regarding the navigation device 10 (e.g., map information, the type, the version, etc.) The map/POI matching unit 25 may be configured to perform map/POI matching based on the information regarding the navigation device 10 (e.g., map information, the type, the version, etc.) stored in the storage 24. The controller 26 may be configured to download, from the telematics server 40, plug-ins to collect the route information and the POI information from route providing servers and installs therein. Since the downloading of plug-ins may incur charges, plug-ins may be downloaded upon a user's permission via the navigation device 10.

The controller 26 may be configured to update previously installed plug-ins in the same manner as the installation. In addition, upon receiving a departure point and a destination from the navigation device 10, the controller 26 may be configured to operate the first route collecting unit 21 to collect first route information from the first route providing server 31, operate the second route collecting unit 22 to collect second route information from the second route providing server 32, and operate the third route collecting unit 23 to collect third route information from the third route providing server 33.

The telematics server 40 may include a plug-in storage 41 configured to store plug-ins provided from the route providing servers 31, 32 and 33, and a plug-in providing unit 42 configured to provide the plug-ins stored in the storage 41 to the telematics module 20. The telematics server 40 may configure a market to sell plus-ins to telematics modules 20, to create profits. Actually, since there is no other cost except for the network usage fee in collecting routes from the route providing servers, it may be possible to create profits by selling plug-ins. The network usage fee may be included in the basic charge for subscribing a telematics service.

As set forth above, according to exemplary embodiments of the present invention, route information may be collected from one or more route-providing servers via a standardized interface in the form of a plug-in upon a user request for routes and then a routing service may be provided based on the route information selected by the user. Accordingly, the user may compare the route information from various routing service providers and selected a route in based on preference or propensity and may be guided along that route, thereby improving reliability and satisfaction on an automotive navigation device. Further, according to exemplary embodiments of the present invention, a standardized interface in the form of a plug-in may be provided, such that routes created by various route information service providers may be used in the navigation device.

In addition, according to exemplary embodiments of the present invention, a standardized interface in the form of a plug-in may be installed in a telematics module, such that routes created by various route information service providers may be utilized when the telematics module is connected, independently of the type and version of a navigation device within a vehicle.

What is claimed is:

1. A multi-path routing telematics system, comprising:
a memory configured to store program instructions; and
a processor configured to execute the program instructions, the program instructions when executed configured to:
receive a route request from a navigation device;
connect to one or more route-providing servers based on corresponding plug-ins; and
collect routes and transmit the collected routes to the navigation device to be output;
wherein the route-providing servers are each configured to create a route pursuant to the route request.

2. The multi-path routing telematics system according to claim 1, further comprising:
a telematics server configured to manage one or more plug-ins and provide a plug-in pursuant to a request for downloading the plug-in.

3. The multi-path routing telematics system according to claim 2, wherein the telematics server is configured to charge for the download of the plug-in.

4. The multi-path routing telematics system according to claim 2, wherein the telematics server includes:
a storage configured to store plug-ins provided from the route providing servers, and
wherein the telematics server is configured to output the plug-ins stored in the storage.

5. The multi-path routing telematics system according to claim 1, wherein the route providing servers include different maps and are configured to create routes based on different route creation engines.

6. The multi-path routing telematics system according to claim 1, wherein the program instructions when executed are configured to perform map matching on the routes collected from the route providing servers.

7. The multi-path routing telematics system according to claim 1, wherein the program instructions when executed are configured to mark point of interest (POI) information on a map on the navigation device, when the POI information is requested.

8. The multi-path routing telematics system according to claim 7, wherein the program instructions when executed are configured to perform POI matching on the POI information provided from the route providing servers.

9. The multi-path routing telematics system according to claim 1, wherein each of the plug-ins stores an address of the respective route providing servers.

10. The multi-path routing telematics system according to claim 1, wherein each of the plug-ins performs user authentication.

11. The multi-path routing telematics system according to claim 1, wherein the program instructions when executed are configured to update the plug-ins regularly.

12. The multi-path routing telematics system according to claim 1, wherein the program instructions when executed are configured to output via the navigation device routing based on a selected route from among a plurality of routes.

13. A multi-path routing method, comprising:
receiving, by a controller, a route request from a navigation device;
connecting, by the controller, to one or more route-providing servers based on corresponding plug-ins; and
collecting, by the controller, routes and transmitting the collected routes to the navigation device to be output;
wherein the route-providing servers are each configured to create a route pursuant to the route request.

14. The method of claim 13, wherein the route providing servers include different maps and are configured to create routes based on different route creation engines.

15. The method of claim 13, further comprising:
performing, by the controller, map matching on the routes collected from the route providing servers.

16. The method of claim 13, further comprising:
marking, by the controller, point of interest (POI) information on a map on the navigation device, when the POI information is requested.

17. A non-transitory computer readable medium containing program instructions executed by a controller, the computer readable medium comprising:
program instructions that receive a route request from a navigation device;
program instructions that connect to one or more route-providing servers based on corresponding plug-ins; and
program instructions that collect routes and transmitting the collected routes to the navigation device to be output;
wherein the route-providing servers are each configured to create a route pursuant to the route request.

18. The non-transitory computer readable medium of claim 17, wherein the route providing servers include different maps and are configured to create routes based on different route creation engines.

19. The non-transitory computer readable medium of claim 17, further comprising:
program instructions that perform map matching on the routes collected from the route providing servers.

20. The non-transitory computer readable medium of claim 17, further comprising:
program instructions that mark point of interest (POI) information on a map on the navigation device, when the POI information is requested.
